(19) United States
(12) Patent Application Publication
(10) Pub. No.: US 2009/0319789 A1
(43) Pub. Date: Dec. 24, 2009

(54) Encrypted portable medical history system

(76) Inventors: Larry Wendell Wilson, Richmond, KY (US); James Max Smith, Richmond, KY (US); Barbara Griec, Richmond, KY (US)

Correspondence Address: JAMES M. FRANCIS, 300 W VINE ST, STOLL KEENON OGDEN PLLC, LEXINGTON, KY, 40507, US

(21) Appl. No.: 12/423,801

(22) Filed: Apr. 14, 2009

Related U.S. Application Data
(60) Provisional application No. 61/044,508, filed on Apr. 14, 2008.

(51) Int. Cl. H04L 9/32

(52) U.S. Cl. 713/168

(57) ABSTRACT

The invention consists of a system of integrated components comprised of at least one portable data storage device, a secure server based system to warehouse data within a database and an image of the computer readable media on the portable data storage device, and a user interface to the secure server. It is contemplated that access to the secure server can be accomplished through a browser via the internet, an intranet, or an extranet. It is further contemplated that a secure client/server arrangement could permit direct access to the database. A client/server arrangement could be of a thin-client or fat-client type architecture. Users would require only a minimal amount of interaction with the system for the purpose of editing information and uploading files, while health care providers would require greater access and reporting for the purpose of facilitating the delivery of appropriate care.

### CROSS REFERENCE TO RELATED APPLICATIONS

This application claims priority from U.S. Provisional Application No. 61/044,508 filed on Apr. 14, 2008. This application relates to a self cleaning gutter system and gutter bracket. The entire disclosure contained in U.S. Provisional Application No. 61/044,508 including the attachments thereto, are incorporated herein by reference.

### BACKGROUND OF THE INVENTION

1. Field of the Invention

This invention relates to a process for the secure storage and retrieval of personal health information and more specifically for the secure storage and retrieval of personal health information by both individuals and health care providers utilizing a credit card sized portable data storage device.

2. Problems in the Art

Emergency medical treatment has always been somewhat risky since little if any personal medical information, such as a medical history, is available to the first responder. There have been efforts to alert first responders through the use of jewelry such as bracelets or necklace pendants, but this has met with limited success due to the constraints on the amount of information that can be conveyed. Many conditions, such as problems with anesthesia or respiratory problems such as sleep apnea, can alter the treatment protocols and if unknown can jeopardize the health or life of the patient.

Another problem is created by the lack of a comprehensive medical history to make available to specialists, pharmacists, and primary care physicians. Often, physicians and pharmacists and are at the mercy of the patient's memory of past procedures and medical service providers. Incomplete information can results is misdiagnoses, inappropriate treatment, and dangerous drug interations.

### SUMMARY OF THE INVENTION

The invention consists of a system of integrated components comprised of at least one portable data storage device, a secure server based system to warehouse data within a database and an image of the computer readable media on the portable data storage device, and a user interface to the secure server. It is contemplated that access to the secure server can be accomplished through a browser via the internet, an intranet, or an extranet. It is further contemplated that a secure client/server arrangement could permit direct access to the database. A client/server arrangement could be of a thin-client or fat-client type architecture. Users would require only a minimal amount of interaction with the system for the purpose of editing information and uploading files, while health care providers would require greater access and reporting for the purpose of facilitating the delivery of appropriate care.

### BRIEF DESCRIPTION OF THE DRAWINGS

FIG. 1 depicts the flow of information between the various system components.

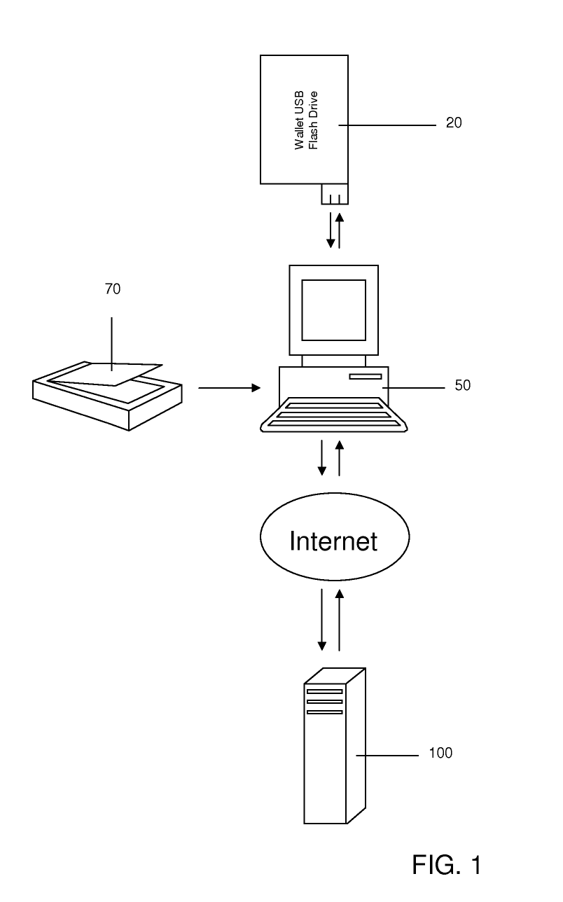

### DETAILED DESCRIPTION OF THE INVENTION

The portable data storage device 20 is preferably small enough to be convenient to carry in a wallet or on a keychain, for example. Preferably, the data storage device 20 is in the shape of a credit card and has an unsheathed USB connector. The device 20 is comprised of a microcontroller and computer readable media, preferably a flash memory chip. The chip's memory is partitioned by software to have a portion that emulates a USB CD-ROM device and a portion that emulates an ordinary USB flash memory device 20.

The user would store important documents and records such as information necessary to identify the cardholder (including a digital photograph that is also duplicated on the face of the data storage device 20) wills, living wills, DNR (do not resuscitate) directives, power of attorney, allergy data, current medication logs, emergency contact information, identification and contact information for next-of-kin, deeds and titles in addition to a plurality of other important and not-so-important documents, photographs, recordings and records in an unencrypted folder. In one embodiment, the chip contains software executables on the flash memory partition to decrypt at least one encrypted folder on the flash memory. This encrypted folder contains the personal information of the user such as financial records, location of important documents log, assets and liabilities log, passwords log, and/or information related to legal matters.

Three main tiers of software are utilized to accomplish the process, (a) server based, (b) client based and (c) device based. Once the portable data storage device 20 and user are authenticated, data passes between the portable data storage device 20 and the server via the host personal computer 50. The software resident on the host computer 50 is used to securely access the information on the portable data storage device 20, update the information on the card 20, and facilitates two-way synchronization between the server 100 and one or more portable data storage devices 20.

Server Side Technologies: Monitoring & Security

The server side technologies are the software agents running on a centralized server 100 which utilize the host computer 50 software as a conduit to interact with the physical memory and CPU of the portable data storage device 20. There are software agents for monitoring, security, data storage and retrieval, third party access controls/data exchange and post-processing. In the preferred embodiment, the message passing is handled via RPC calls over a secure HTTP connection. This means the centralized server 100 can be anywhere on the internet, and the device 20 can sync over public and private networks alike. Also, in this implementation, the host computer 50 is not necessarily treated as a trusted platform—only the self-contained CPU on the memory device 20 and the centralized server 100 are treated as “trusted” in this implementation.

Software agents monitor the incoming RPC requests from the host computer 50 software and audit them for access control, to detect tampering and to provide an audit trail which logs each transaction and the details of the login itself. Because the flash interface goes through the CPU on the portable data storage device 20, the CPU can request handshakes or decryption keys for specific blocks of data on the flash chip. Encoded in these requests can be things such as bytes transferred from a USB memory device (as the portable data storage device) to host computer 50 during this session and the software agents store and log this information, or they may use this information to detect anomalous transfers of data, and remotely shutdown the USB card 20 by sending an encrypted response through the computer. These agents running on the server could dump this information to a simple logging utility or run another program to take a proactive approach such as emailing an administrator, blocking an IP address, etc.

Server Side Technologies: Data Storage and Retrieval

In the preferred embodiment, data stored on the portable data storage device 20 is always synced back to the centralized server 100 whenever possible. Some implementations of the portable data storage device 20 may not require real-time centralized server 100 access in order to read or read/write information in some or all blocks of data on the flash memory chip. In this case, the host computer 50 software could notify the user of un-synchronized information during use and/or automatically check for a usable communications path to the centralized server when the desktop software starts up. The data storage and retrieval software agent exposes an API through the RPC element to give the desktop software the ability to read and write files either stored on a “normal” desktop file system on the flash chip, or in special/hidden blocks on the USB flash chip. The blocks of data can be delivered to the CPU on the memory storage device 20 in both an encrypted and unencrypted form. In the event multiple portable data storage devices 20 sync back to one central server 100 folder, the data storage and retrieval agents also manage conflict and would store both versions of the data for conflict resolution. The agents can manage which blocks of data are write protected and which blocks of data are read/write as well.

Server Side Technologies: Third Party Access Control

The third party access control software agents handle read only, read/write or write-only access to the information stored on the server 100. This interface would facilitate other software & services communication with the information stored on the server 100. If the interface were used to update information on a corresponding USB memory card 20 (as a portable data storage device 20), it could download the update from the centralized server upon initial check-in. Alternative embodiments may prompt the user that updated information is available, etc. Another embodiment may write protect the updated portion on the USB memory device 20 unless the device 20 is updated to help prevent conflict. This type of software agent could also provide interface for third party data services, such as Google Health, for automatically collecting data from third parties on behalf of a the USB memory card 20 user. Some software agents in this category could run on a periodic schedule to check for updates.

Server Side Technologies: Post-Processing

Post-processing software agents lower the cost and complexity of licensing data manipulation programs on behalf of USB memory card/portable data storage device 20 users. An example post-processing agent API exposed through RPC would be an OCR application. The client side software has an interface to ordinary USB document scanners 70 and the document is scanned and submitted as an image to this software agent (running on the centralized server) for processing. The post-processing agent could then OCR the document and store/sort the recognized information as part of the OCR and send the processed block of data back to the USB memory card 20 (as well as store the information locally).

Client Side: Personal Computer Software

In the preferred embodiment, the client side/personal computer software acts as a communication conduit between the user, the CPU on the USB memory device 20 and the centralized server 100. For security reasons the host computer 50 software might not be trusted in the security model because a malicious user may be able to modify the host computer 50 software either in memory or at runtime. The host computer 50 software may provide an interface, “wizards” or other user interface front-end to the functionality exposed on the server 100 via the RPC interface. The host computer 50 software could typically retrieve the card 20 serial number, cryptographic hash, etc. It could prompt the user for their password or pin number or other information. The host computer 50 software could also provide access to any standard biometric hardware or RFID reader attached to the computer 50 as well in alternative embodiments.

The client software may pass fully encrypted, partially encrypted or unencrypted messages between the centralized server 100 and the CPU on the USB memory card 20. Depending on the security goals and functionality goals of the user, different functionality could be achieved with different software loaded on to the CPU. The client software on the host computer 50 could also act to receive and upload data from peripheral devices such as scanners 70, cameras, diagnostic instrumentation, or other sources of medical data. Preferably an optical character recognition software program is available for use with the scanner 70.

Personal Data Storage Device

The software running on the CPU of the personal data storage device/USB memory storage device 20 can control access to the flash memory chip on board. The chip may have encryption protocols such that the information on the flash memory chip is encrypted and this encryption may be otherwise transparent to the host. In addition, encrypted messages from the central server 100 may be decoded and executed by the CPU on the host. Commands available in the preferred implementation include, but are not limited to, commands for reading, writing and locking the flash memory so it cannot be accessed at all. There would also be commands for retrieving encryption keys, hashes, etc. to facilitate secure communication between the CPU on the card 20 and the centralized server 100. Because of the modular architecture outlined herein, the CPU on the USB memory storage device 20 may be loaded with one or more software components to facilitate the information storage, retrieval, encryption, etc.

Because of the access to the USB interface, the CPU can also be loaded with software to implement emulation of other USB devices. In order to make things easier for end users, the device would (in the preferred embodiment) implement a CD-ROM emulation. The advantage is the host computer 50 operating system very often automatically executes specially crafted files that are normally found on CD-ROMs. In the preferred embodiment this provides both a mechanism for automatically having the host computer 50 execute the desktop software and the security of automatically preventing the host computer 50 from being able to modify the contents of the emulated CD-ROM. The host computer 50 software could be leveraged to allow secure/verified updates and changes to the CD-ROM area of the flash chip. Alternative embodiments may include software modules loaded onto the USB memory device 20 CPU that would emulate smartcard reader technology, USB human interface devices or other USB peripherals for various reasons, including (but not limited to) integration with existing security technology (such as pre-existing smartcard deployment).

In one embodiment, the data storage device 20 also possesses software programmed to bi-directionally or uni-directionally synchronize the data and/or image on the data storage device with the secure server 100. The user may update their information on-line and save the updated files to the device. It is further contemplated that the records stored on the device could be updated by a health care provider and subsequently sent to on-line storage at the secure database through an on-line synchronization procedure. This can be accomplished through combinations of HTTPS services and/or XML/RPC service calls.

The portable data storage device 20 contains an interface chip and flash memory. In the preferred embodiment, the interface chip is arranged between the host computer 50 and the portable data storage device's 20 flash memory chip. The interface chip is programmable and can be loaded with one or more programs, some of which may be incompatible with each other, to produce a distinct feature set.

The flash memory chip on the portable data storage device 20 is capable of being loaded with software modules that expose to the host computer 50 a “normal” read/write flash drive as found in typical USB memory devices, a CD-ROM area (which, to the host computer, appears to be a CD ROM), keyboard, mouse, smart-card reader or virtually any other USB device.

Areas of the flash which appear to the host computer to be a normal file system, CD-ROM or other data storage device 20 can contain executable code that can run on the host personal computer. In the preferred embodiment at least one region of the flash memory chip contains a file system compatible with the host computer 50 and contains the companion client program.

The companion client program could contain modules that reflect the APIs exposed from the centralized server RPC services as well as modules. For example, the host computer 50 software could run on the host computer 50 from a read-only portion of the flash memory chip exposed to the host as a CD-ROM and the CPU on the memory storage device 20 could require check-in and handshake from the centralized server 100 before unlocking an encrypted block, allowing updates or any combination thereof.

In an alternative embodiment, the portable data storage device 20 may simply show up on the host machine as if it were a smart card reader with smartcard inserted until a PIN or Password authentication on the host 50 had been completed. The CPU on the memory device 20 could then unlock other areas of the flash memory chip and/or other functionality such as a read/write flash drive, CD-ROM or other device.

In yet another alternative embodiment, the portable data storage device 20 may provide only a simple password request before allowing unencrypted access to the flash memory chip and presenting it to the host computer 50 as a normal read/write flash drive. This feature would ordinarily not be possible in combination with some of the more exotic access control methods outlined above because other modules might require a real-time two-way communication with a centralized server 100.

The portable data storage device 20 will contains a read-only portion, encrypted portion, read-write portion, hidden portion or any combination thereof. The particulars of the implementation of security and access control could come in to conflict, but because the intelligence is on the portable data storage device 20 and it is a “trusted” platform, it affords much greater flexibility than if the security and access control were implemented exclusively on the host computer 50.

A USB memory storage device 20 could be created using these modules that requires a real-time centralized server 100 to approve or deny authorization requests with very fine granularity, down to individual blocks or individual files if necessary. The access to the real-time centralized server 100 could be through RPC over secure HTTP connections, generic RPC over XML services or even through existing security infrastructure (by emulating it) such as smart card enrollment.

The portable data storage device 20 can be configured to permit access to the centralized server 100 only in certain conditions such as, but not limited to, too many security failures, unrecognized source machine, etc. This might mean read-only access is available until an update occurred or a verification process could reset vital security parameters.

In addition, the host computer 50 software could include modules that push updates from the server back to the card either in block or file form. The updates may be unencrypted in the case of direct file manipulation in a read/write block of the flash chip, encrypted or partially encrypted. The combination of host computer 50 software, server 100 services and programs loaded on to the USB flash memory card 20 for one end-to-end scenario would not necessarily be compatible with another end-to-end scenario. For example, the suite of centralized-server 100 modules, host computer 50 software and modules running on the portable data storage device 20 assembled from the modular components, and setup for RPC over HTTPs would not work in an environment where the centralized-server communication was required to be through another technology, such as RPC over XML or even RPC over DCOM. Further, modules requiring most of the memory on the USB M S D could be locked until handshake would not be compatible with modules that have looser security requirements. Further still, portable data storage device 20 could be created from modules that simply synchronize one way from centralized server 100 to card 20 to “guarantee” a secure channel from Server 100 to Storage Device 20 that would not be affected by a compromised host PC 50.

It is further envisioned that an encryption key could be stored on the card 20 itself as a software security token. The card 20 itself could also function as a hardware security token. Preferably, the card would be a connected token. Connected tokens must be physically connected to the client computer. Connected tokens will automatically transmit the authentication info to the client computer once a physical connection is made. However, in order to use a connected token the appropriate input device must be installed. The most common types of physical tokens are smart cards and USB tokens, which require a smart card reader and a USB port respectively. The card 20 is memory device with a USB 2 or USB 3 connector, therefore a USB token is preferred. The connector could also be a USB 2 compatible USB 3 connector.

Another preferred token would be a smart-card-based USB token. Smart-card-based USB tokens contain a smart card chip and provide the functionality of both USB tokens and smart cards. They enable a broad range of security solutions and provide the abilities and security of a traditional smart card without requiring a unique input device. From the computer operating system's point of view such a token is a USB-connected smart card reader with one non-removable smart card present. Ideally, Two-factor authentication would be used. Two-factor authentication is a system that uses two different factors in conjunction to authenticate, such as the combination of a password with a security token. Using two factors as opposed to one factor generally delivers a higher level of authentication assurance.

It is further contemplated that documents, photographs, x-rays, lab reports, instrument scans, blood chemistry reports and other such records containing medical information can be sent to a service provider that maintains the database and secure server 100, or simply interfaces with it, for upload into the database in some machine readable format. These updates can be synchronized back to the storage device 20 when a communications link is established. This gives the user the freedom to choose their health care service provider regardless of that provider's ability to ability to directly access the database. It is contemplated that instructions for use by health care providers will be stored in the unencrypted folder of the device 20.

Ideally the user will be directed to fill out information in standardized forms that contains fields commonly utilized in the collection of personal information by most health care providers. The availability of a standardized form could obviate the need for manual entry of important data on office forms and subsequent retyping into the systems of a medical office. This reduces the risk of clerical error at the office of the medical provider. Prescription histories would ideally be stored on the device 20 as well. One alternative embodiment provides that that the database would flag potential drug interactions and notify the user and/or the health care provider.

It is further contemplated that medical providers could provide data to a third party to verify its authenticity and accuracy before being made part of the user's record. Such information could be stored in an on-line holding area for review by the third party and/or the user prior to transfer into the user's personal information or medical history.

Creation of data files from paper documents is also envisioned to be possible through the client interface. Documents, photographs, x-ray images and the like can be scanned in by the user, preferably at a recommended resolution, and uploaded into the on-line database directly or loaded into the storage device for synchronization. Synchronization can be implemented as a browser plug-in or as a standard windows application. In one embodiment, files and/or associated file sizes and/or date stamps would be compared and contrasted to determine if files need to be uploaded to the device or to the server. In another embodiment, the device would be updated directly by the database service provider. In yet another embodiment, the medical services provider could update the device 20 and/or the online database directly.

The data storage device 20 disclosed herein could be used by insurers to provide a means to minimize risk associated with mistakes by healthcare providers receiving erroneous information. A business model wherein part of the cost savings derived from the use of the data storage device would be passed along to users would provide enhanced profit to the insurer and an incentive to the end user. Similar business models are employable by health care providers so as to minimize their risk and thus reduce their premiums upon implementation of the disclosed data storage device. In one embodiment, patients would receive a card upon entry to a hospital or any health care provider for current and future use. The cost of the data storage device 20 would be covered as a medical expense by the insurer or the end user, thereby reducing the overhead associated with the dispensing of the data storage devices 20.

An additional business model requires the use of the cards by students at universities and other schools.

What is claimed is:

1. (canceled)

2. A data storage device comprising:
a portable data storage device; an interface through which said device communicates with a computer; a non-volatile computer accessible memory, a public folder on said portable data storage device; at least one encrypted partition on said non-volatile memory of said portable data storage device; a data processor; a database to warehouse personal and medical data as well as data images of individual said portable data storage devices, said database being installed on at least one secure server accessible over a computer network and capable of being updated by secure remote bi-directionally synchronization with said portable data storage device over said network.

3. The data storage system of claim 2, wherein said medical data is selected from the group consisting of x-ray photographs, imaging scans, blood chemistry, pharmaceutical history, allergy history, current medical conditions, and past medical conditions.

4. The data storage system of claim 3, wherein said personal data is selected from the group consisting of biometric information, wills, social security numbers, powers of attorney, personal directives, insurance information, emergency contacts, financial information, photographs, and videos.

5. The data storage system of claim 4, further including at least one public partition on said non-volatile memory.

6. The data storage system of claim 5, further including a security token on said portable data storage device, said security token enabling secure user authentication.

7. The data storage system of claim 6, wherein the security token is comprised of the group consisting of software and hardware tokens.

8. The data storage system of claim 7, wherein said software security token is comprised of the group consisting of mathematical-algorithm-based one-time passwords and time-synchronized one-time passwords.

9. The data storage device of claim 2, wherein said portable data storage device contains more than one encrypted partition.

10. The data storage device of claim 9, wherein said portable data storage device's encrypted partitions utilize different encryptions.

11. The data storage device of claim 10, wherein said portable data storage device contains more than one security token.

12. The data storage device of claim 11, wherein said portable data storage device's security tokens secure different partitions.

13. A data storage system comprising:
a. a portable data storage device, wherein said device has a central processing unit, a non-volatile flash memory, and an interface for establishing connections with computers, wherein said memory is capable of storing a personal medical history and is further capable of allowing said personal medical history to be retrieved, is capable of being partitioned into areas of differing levels of encryption and wherein said central processing unit resides between said non-volatile flash memory and said interface;
b. a security token on said portable data storage device, said security token enabling secure user authentication;
c. software modules on said portable data storage device, said software modules enabling said partitions on said portable data storage device to emulate USB interfaced media storage devices;
d. a computer server, said server possessing server side software to authenticate a security token on said portable data storage device, securely database personal medical information, receive and database uploaded medical history updates; and said computer server being accessible via a computer network; and
e. a host computer, said host computer possessing client side software to facilitate the transfer of data between said computer server and said portable data storage device.
